(19) United States
(12) Patent Application Publication
(10) Pub. No.: US 2014/0113498 A1
(43) Pub. Date: Apr. 24, 2014

(54) CONNECTOR AND ELECTRONIC DEVICE HAVING THE SAME

(71) Applicant: HOSIDEN CORPORATION, Yao-shi (JP)

(72) Inventors: Daisuke SASAKI, Yao-shi (JP); Takayuki NAGATA, Yao-shi (JP)

(73) Assignee: HOSIDEN CORPORATION, Yao-shi (JP)

(21) Appl. No.: 14/057,238

(22) Filed: Oct. 18, 2013

(30) Foreign Application Priority Data
Oct. 22, 2012 (JP) 2012-232754

(51) Int. Cl. H01R 24/62

(52) U.S. Cl. CPC H01R 24/62
USPC 439/676

(57) ABSTRACT

The invention provides a connector including a body and a plurality of first and second contacts embedded at least partially in the body. The body includes a main body and a tongue extending from the main body to one side in a first direction. The tongue includes a first face facing one side in a second direction, the second direction crossing the first direction. The first contacts include first contact portions. The first contact portions are embedded in the tongue in spaced relation to each other along a third direction crossing the first and second directions to be exposed from the first face of the tongue. The second contacts include second contact portions. The second contact portions are embedded in the tongue in spaced relation to each other along the third direction to be exposed from the first face of the tongue.

### CROSS-REFERENCE TO RELATED APPLICATIONS

The present application claims priority under 35 U.S.C. §119 of Japanese Patent Application No. 2012-232754 filed on Oct. 22, 2012, the disclosure of which is expressly incorporated by reference herein in its entity.

### BACKGROUND OF THE INVENTION

1. Technical Field

The invention relates to a connector and an electronic device having the same.

2. Background Art

Japanese Patent Application Laid-Open (JP-A) No. 2010-10129 discloses a connector including a body, and a plurality of first and second contacts arranged in the body. The body includes a main body and first and second tongues provided in the main body. The upper and lower faces of the second tongue are provided with a plurality of grooves arrayed in spaced relation to each other along a widthwise direction of the connector. The first contacts have first contact portions arrayed in spaced relation to each other along the widthwise direction to be exposed from the lower face of the first tongue. The second contacts have second contact portions accommodated in the grooves in the second tongue, and the ends of the second contact portions project from the grooves.

### SUMMARY OF INVENTION

In the above conventional connector, the first and second tongues are provided in spaced relation to each other in the main body. The first contacts are arranged in the body with their first contact portions exposed from the first tongue. The second contacts are arranged in the body with their second contact portions projecting from the grooves in the second tongue. This arrangement causes increased dimension of the connector, particularly in the arrangement direction of the first and second tongues.

The invention includes been made in view of the circumstances. The invention provides a connector with a reduced dimension in a direction. The invention also provides an electronic device having the same connector.

The invention provides a connector including a body and a plurality of first and second contacts embedded at least partially in the body. The body includes a main body and a tongue extending from the main body to one side in a first direction. The tongue includes a first face facing one side in a second direction, the second direction crossing the first direction. The first contacts include first contact portions. The first contact portions are embedded in the tongue in spaced relation to each other along a third direction crossing the first and second directions to be exposed from the first face of the tongue. The second contacts include second contact portions. The second contact portions are embedded in the tongue in spaced relation to each other along the third direction to be exposed from the first face of the tongue.

In the connector of this aspect of the invention, the first and second contact portions of the first and second contacts are embedded in the tongue to be exposed from the first face of the tongue of the body. This configuration can reduce the dimension in the second direction of the connector.

The first and second contact portions may be alternately arrayed to form a staggered array along the third direction.

In the connector of this aspect, exposing the first and second contact portions from the same face (i.e. the first face) of the tongue will not significantly increase the dimension in the third direction of the connector because of the staggered array in the third direction of the first and second contact portions. This staggered array can make the connector adapted for two different types of mating connectors for the following reasons. When the first contact portions contact contacts of a first type of mating connector, the second contact portions are less likely to contact contacts of the first mating connector because of the staggered array. When the second contact portions contact contacts of a second type of mating connector, the first contact portions are less likely to contact the contacts of the second mating connector because of the staggered array. The connector may also be connectable with a third type of mating connector having contacts that are contactable with both the first and second contact portions because the first and second contact portions are exposed from the same first surface in the staggered array.

The second contacts may further include second contact bodies embedded in the body. The first contacts may further include bent portions and first contact bodies. The bent portions may extend to the other side in the second direction and be embedded in the tongue. The first contact bodies may be contiguous with respect to the bent portions, bent with respect to the bent portions to the other side in the first direction and embedded in the body to be located on the other side in the second direction of the second contact portions.

In the connector of this aspect, the first contacts includes the bent portions extending to the other side in the second direction and the first contact bodies located on the other side in the second direction of the second contact portions. This configuration can suppress an increase in the dimension in the third direction of the connector.

The second contact portions may be embedded in the tongue in spaced relation to each other along the third direction to be exposed from an area of the first face of the tongue on the other side in the first direction from the first contact portions. The second contacts may further include extended portions. The extended portions may extend from the second contact portions to the one side in the first direction and be embedded in the tongue to be each exposed from between adjacent two of the first contact portions in the first face of the tongue.

In the connector of this aspect, if the second or third mating connector moves to the one side in the first direction with its contacts in contact with the second contact portions (in a connected state), the contacts of the second or third mating connector will contact the extended portions. In other words, if the second or third mating connector moves from the connected state to the one side in the first direction, it is possible to maintain secure contact between the contacts of the second or third mating connector and the second contacts. This improves the connection reliability of the connector.

The connector may further include third and fourth contacts embedded at least partially in the body. The tongue may further include a second face on one side in the third direction of the tongue and a third face on the other side in the third direction of the tongue. The third contact may include a third contact portion, the third contact portion being embedded in the tongue to be exposed from the second face of the tongue. The fourth contact may include a fourth contact portion, the fourth contact portion being embedded in the tongue to be exposed from the third face of the tongue.

In the connector of this aspect, the third and fourth contact portions are embedded in the tongue to be exposed from the second and third faces of the tongue. The addition of the third and fourth contacts will not lead to increased dimensions in the second and third directions of the tongue. Accordingly, this aspect of the invention can suppress the increase in dimensions in the second and third directions of the connector.

The second and third faces of the tongue may each include a distal area on the one side in the first direction and a basal area on the other side in the first direction. The third contact portion may be embedded in the tongue to be exposed from the basal area of the second face. The fourth contact portion may be embedded in the tongue to be exposed from the basal area of the third face.

In the connector of this aspect, the third and fourth contact portions, embedded in the basal areas of the second and third faces of the tongue (i.e., the side faces on one and the other sides in the third direction of the basal portion of the tongue), function as reinforcers of the tongue. This arrangement improves the prying resistance of the tongue.

The distal areas of the second and third faces may be inclined with respect to the basal areas such that the distance between the distal areas is gradually reduced toward the one side in the first direction of the tongue.

In the connector of this aspect, by thus configuring the distal areas of the second and third faces, the tongue can be easily inserted into a connection hole in the mating connectors.

The third and fourth contacts may further include a third contact body embedded in the body. The fourth contact may further include a fourth contact body embedded in the body.

The first contacts may further include first tails projecting from the main body. The second contacts may further include second tails projecting from the main body.

The first and second tails may be arrayed in spaced relation to each other in a row along the third direction.

In the connector of this aspect, the arraying the first and second tails arrayed in a single row can reduce the mounting area of the connector in the circuit board.

The first contacts may further include first tails projecting from the main body. The second contacts may further include second tails projecting from the main body. The third contact may further include a third tail projecting from the main body. The fourth contact may further include a fourth tail projecting from the main body.

The first, second, third, and fourth tails may be arrayed in spaced relation to each other in a row along the third direction.

In the connector of this aspect, the arraying the first to fourth tails arrayed in a single row can reduce the mounting area of the connector in the circuit board.

The connector may further include a tuboid shield case fixed to the main body. The tongue may be disposed in the shield case.

In the connector of this aspect, when the shield case receives a mating connector, the contacts of the mating connector will contact the first and/or second contact portions exposed from the first face of the tongue.

The tuboid shield case may alternatively cover at least a part of the body. In this case, the body may further include a tuboid portion provided in the main body, and the tongue may be disposed in the tuboid portion.

In the connector of this aspect, when the tuboid portion of the body receives a mating connector, the contacts of the mating connector will contact the first and/or second contact portions exposed from the first face of the tongue.

The second contacts may comply with a Micro-USB standard.

An electronic device of the invention includes the connector of any one of the above aspects.

### BRIEF DESCRIPTION OF DRAWINGS

FIG. 1A is a front, bottom, right side perspective view of a connector according to Embodiment 1 of the invention.

FIG. 1B is a rear, top, left side perspective view of the connector.

FIG. 2A is a cross-sectional view of the connector taken along line 2A-2A in FIG. 1A.

FIG. 2B is a cross-sectional view of the connector taken along line 2B-2B in FIG. 1A.

FIG. 2C is a cross-sectional view of the connector taken along line 2C-2C in FIG. 1A.

FIG. 3A is a front, bottom, right side perspective view of a body and first and second contacts of the connector.

FIG. 3B is a rear, top, left side perspective view of the body and the first and second contacts of the connector, with the body illustrated transparently.

FIG. 4A is a front, bottom, right side perspective view of the first and second contacts of the connector.

FIG. 4B is a plan view of the first and second contacts of the connector.

FIG. 5A is a front, top, right side perspective view of a shield case of the connector.

FIG. 5B is a rear, bottom, left side perspective view of the shield case of the connector.

FIG. 6A is a front, bottom, right side perspective view of a body and first to fourth contacts of a connector according to Embodiment 2 of the invention.

FIG. 6B is a front, bottom, left side perspective view of the body and the first to fourth contacts of the connector.

FIG. 7A is a front, top, right side perspective view of the first to fourth contacts of the connector.

FIG. 7B is a rear, top, left perspective view of the first to fourth contacts of the connector.

### DESCRIPTION OF EMBODIMENTS

The following sections describe Embodiments 1 and 2 of the invention.

### Embodiment 1

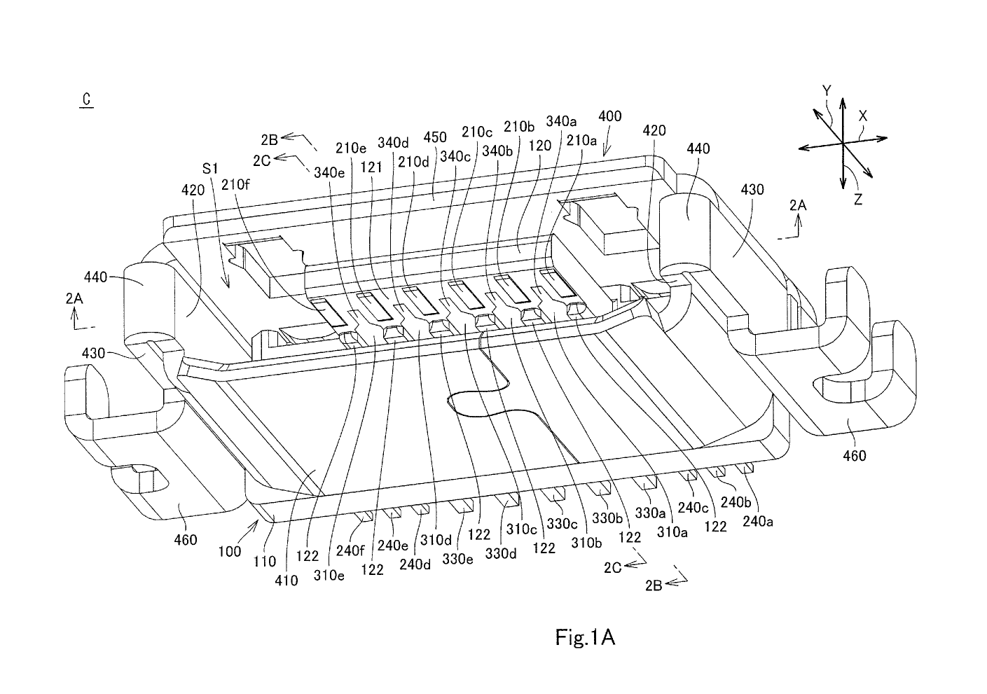

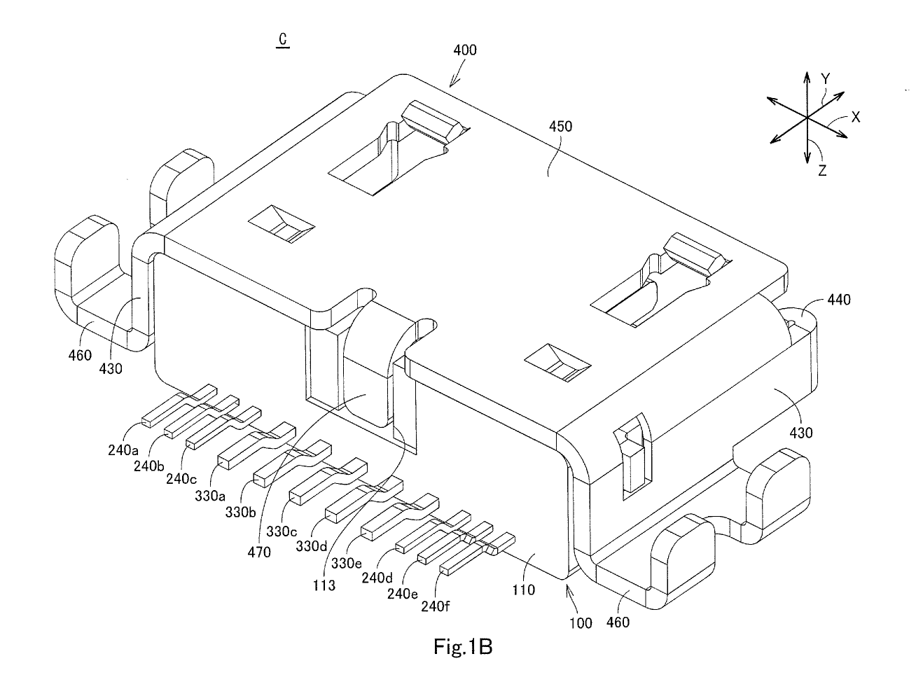

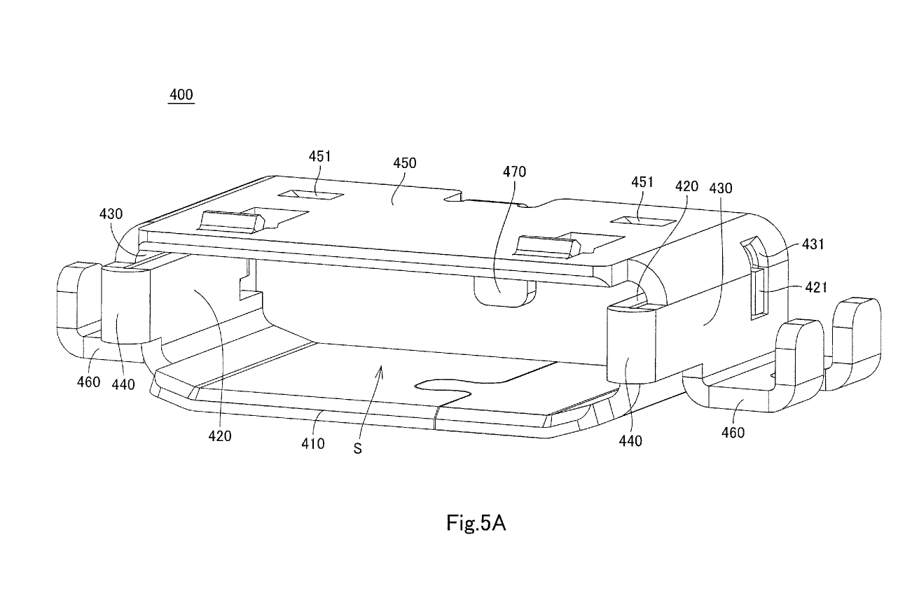

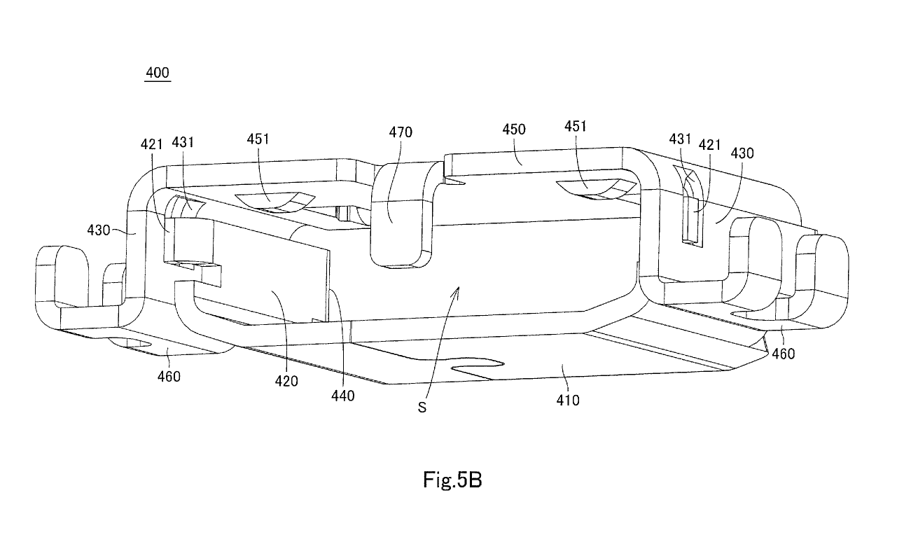

First, a connector C according to Embodiment 1 of the invention will be described with reference to FIGS. 1A to 5B. The connector C shown in FIGS. 1A and 1B is a multi-standard connector adapted to two standards. The connector C includes a body 100, first contacts 200a to 200f, second contacts 300a to 300e, and a shield case 400. Each of these components of the connector C will be described below in detail. As indicated in FIGS. 1A and 1B, a first direction Y is the lengthwise directions of the connector C, the body, and the first and second contacts and also the inserting/removing directions of first, second, and third mating connectors (to be described). A second direction Z is the height direction of the connector C. A third direction X is the widthwise directions of the connector C, the body, and the first and second contacts. The second direction Z is orthogonal to the first direction Y, and the third direction X is orthogonal to the first and second directions Y and Z.

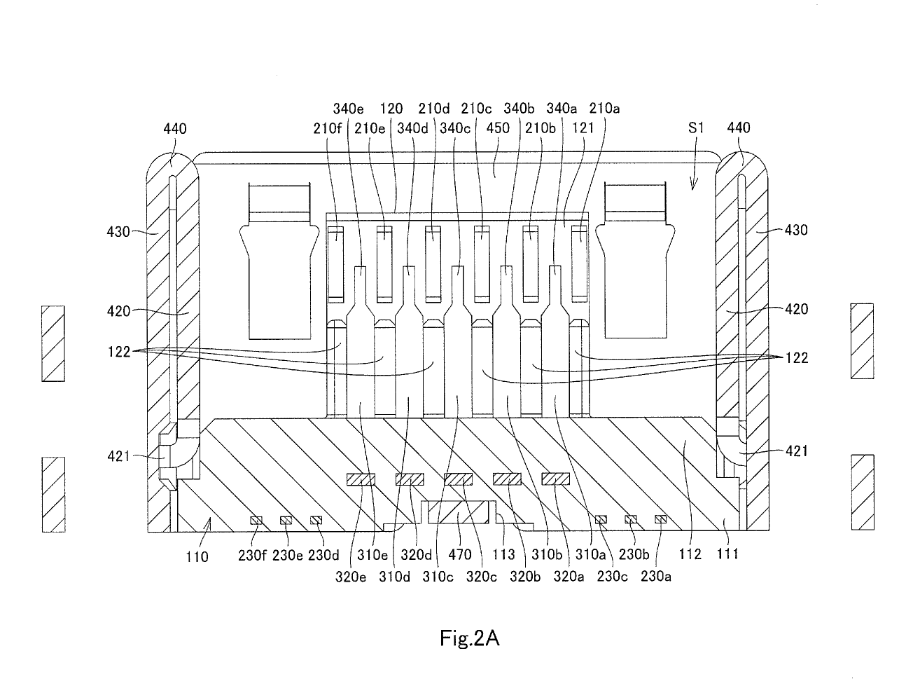

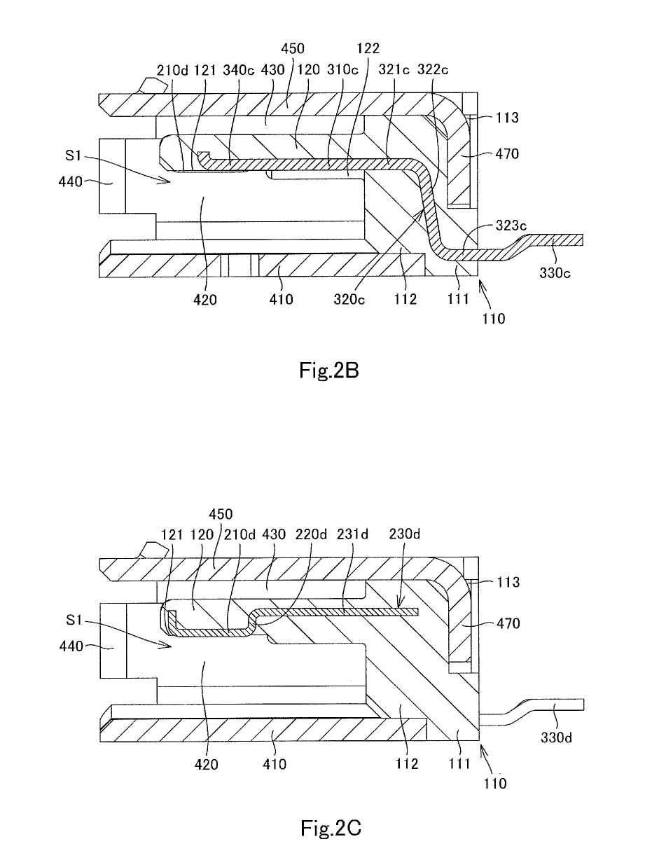

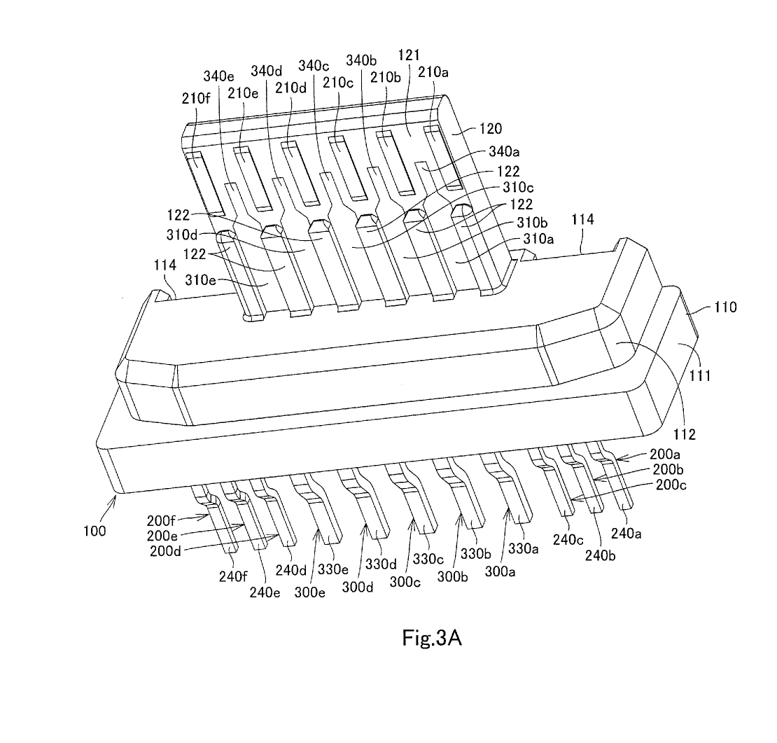

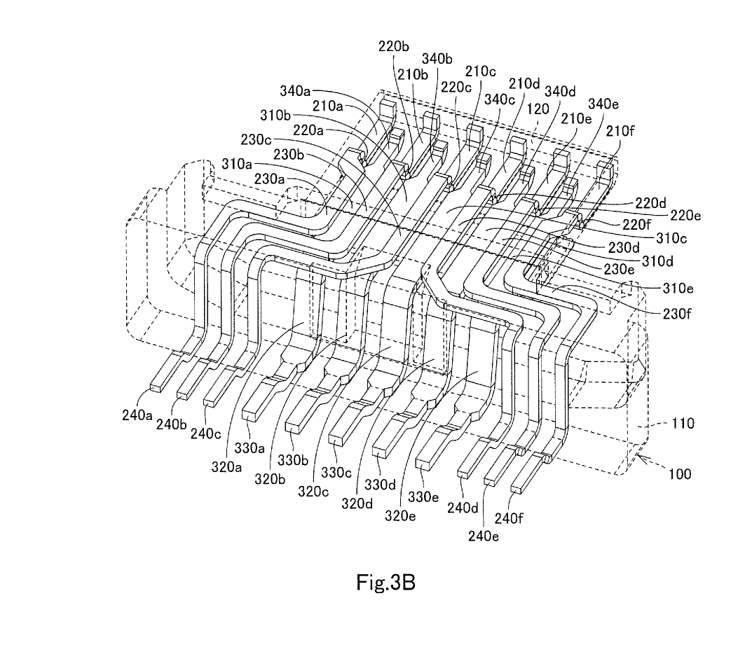

The body 100 is made of an insulating plastic material. As shown in FIGS. 2A to 3B, the body 100 includes a main body 110 and a tongue 120. The main body 110 is a generally rectangular block. The main body 110 includes a plate 111, a projection 112, an engaging recess 113, and a pair of engaging recesses 114. The plate 111 is a rectangular plate. The projection 112 is provided on the face on one side in the first direction Y (the front face) of the plate 111. The projection 112 is of a generally hexagonal shape conforming to the inner shape of the shield case 400. The projection 112 has a smaller outer shape than the plate 111. The engaging recesses 114 are provided at the opposite end portions in the third direction X of the projection 112. The engaging recess 113 is provided at the center of the face on the other side in the first direction Y (the rear face) of the plate 111.

The tongue 120 is a generally rectangular plate projecting from the face on one side in the first direction Y (the front face) of the projection 112 of the main body 110. The tongue 120 extends from the main body 110 to the one side in the first direction Y. The tongue 120 includes a first face 121 and a plurality of guiding projections 122. The first face 121 is the face on one side in the second direction Z (the lower side), i.e. the lower face, of the tongue 120. The first face 121 includes an area on one side in the first direction Y (a distal area) and an area on the other side in the first direction Y (a basal area). The guiding projections 122 are provided in the basal area of the first face 121, in spaced array along the third direction X. The guiding projections 122 are ridges extending in the first direction Y.

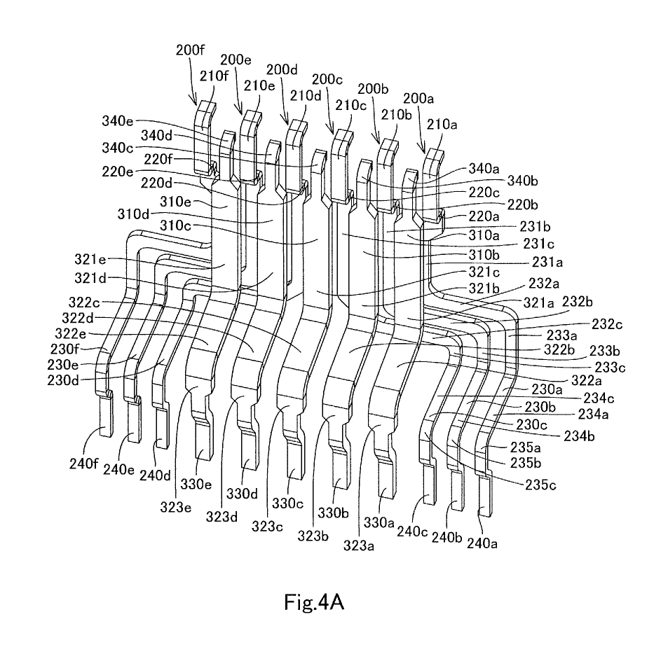

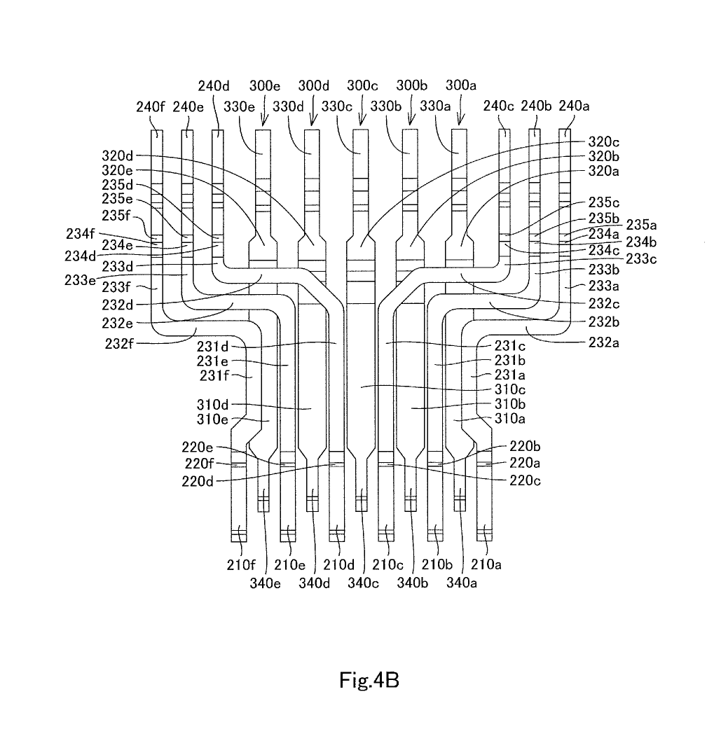

The first contacts 200a to 200f as shown in FIGS. 2C, 4A, and 4B are made of metal plates. The first contacts 200a to 200f comply with one of the two standards mentioned above. The first contacts 200a to 200f have first contact portions 210a to 210f, bent portions 220a to 220f, first contact bodies 230a to 230f, and first tails 240a to 240f.

The first contact portions 210a to 210f are plates extended in the first direction Y and in the third direction X. The contact faces of the first contact portions 21 0a to 210f are the end faces on the one side in the second direction Z (the lower side), i.e. the lower faces. The first contact portions 210a to 210f are embedded in the tongue 120 such that their contact faces are exposed from the distal area of the first face 121 of the tongue 120 in spaced relation to each other along the third direction X. That is, the first contact portions 210a to 210f are arrayed in spaced relation to each other in a row along the third direction X. The contact faces of the first contact portions 210a to 210f are located further to the one side in the second direction Z than the first face 121 of the tongue 120 (see FIGS. 2B and 2C). That is, the first contact portions 210a to 210f are slightly projecting from the first face 121 of the tongue 120 to the one side in the second direction Z. The portions on the one side in the first direction Y (the distal portions) of the first contact portions 210a to 210f are bent to the other side in the second direction Z (to the upper side) and embedded in the tongue 120. This arrangement increases the contact areas of the first contact portions 210a to 210f that are in contact with the tongue 120, resulting in increased retaining forces of the tongue 120 with respect to the first contacts 200a to 200f.

The bent portions 220a to 220f are plates contiguous with the first contact portions 210a to 210f and extend to the other side in the second direction Z (to the upper side). That is, the bent portions 220a to 220f are bent with respect to the first contact portions 210a to 210f to the other side in the second direction Z (to the upper side). The bent portions 220a to 220f are embedded in the tongue 120.

The first contact bodies 230a to 230f are plates contiguous with the bent portions 220a to 220f and bent to the other side in the first direction Y, and they are embedded in the body 100 (particularly in the main body 110 and the tongue 120). The first contact bodies 230a to 230f include first plates 231a to 231f, second plates 232a to 232f, third plates 233a to 233f, fourth plates 234a to 234f, and fifth plates 235a to 235f. The first plates 231a to 231f contiguously extend from the bent portions 220a to 220f to the other side in the first direction Y. The second plates 232a to 232f contiguously extend from the first plates 231a to 231f in the third direction X. More particularly, the second plates 232a to 232c extend to the one side in the third direction X (to the right side in plan view as shown in FIG. 4B), and the second plates 232d to 232f extend to the other side in the third direction X (to the left side plan view as shown in FIG. 4B). The third plates 233a to 233f contiguously extend from the second plates 232a to 232f to the other side in the first direction Y. The fourth plates 234a to 234f contiguously extend from the third plates 233a to 233f to the one side in the second direction Z (to the lower side). There is a wide gap between the fourth plates 234c and 234d. The fifth plates 235a to 235f contiguously extend from the fourth plates 234a to 234f to the other side in the first direction Y. There is a wide gap between the fifth plates 235c and 235d.

The first tails 240a to 240f are plates contiguous with the first contact bodies 230a to 230f and extend to the other side in the first direction Y. More particularly, the first tails 240a to 240f are contiguous with the fifth plates 235a to 235f of the first contact bodies 230a to 230f and project from the main body 110 of the body 100 to the other side in the first direction Y. There is a wide gap between the first tails 240c and 240d.

The second contacts 300a to 300e as shown in FIGS. 2B, 4A, and 4B are made of metal plates. The second contacts 300a to 300e comply with the other of the two standards mentioned above, which may be the Micro-USB standard. The second contacts 300a to 300e include second contact portions 310a to 310e, second contact bodies 320a to 320e, second tails 330a to 330e, and extended portions 340a to 340e.

The second contact portions 310a to 310e are plates extending in the first direction Y and in the third direction X. The contact faces of the second contact portions 310a to 310e are the end faces on the one side in the second direction Z (the lower side), i.e. the lower faces. The second contact portions 310a to 310e are embedded in the tongue 120 such that their contact faces are exposed from between the guiding projections 122 in the basal area of the first face 121 of the tongue 120. That is, the second contact portions 310a to 310e are arrayed on the other side in the first direction Y from the first contact portions 210a to 210f, in spaced relation to each other in a row along the third direction X. As shown in FIGS. 1A and 2A to 2C, the second contact portions 310a to 310e and the first contact portions 210a to 210f are alternately disposed to form a staggered array along the third direction X. The contact faces of the second contact portions 310a to 310e are flush with the first face 121 of the tongue 120 (see FIG. 2B).

The extended portions 340a to 340e are plates contiguous with the ends on one side in the first direction Y of the second contact portions 310a to 310e and extend to the one side in the first direction Y. The extended portions 340a to 340e each have a smaller dimension in the third direction X than the associated second contact portions 310a to 310e. The contact faces of the extended portions 340a to 340e are the end faces on the one side in the second direction Z. The extended portions 340a to 340e are embedded in the tongue 120 such that the contact faces thereof are exposed from the distal area of the first face 121 of the tongue 120 in spaced relation to each other along third direction X. More specifically, the extended portion 340a is disposed between the first contact portions 210a and 210b; the extended portion 340b is disposed between the first contact portions 210b and 210c; the extended portion 340c is disposed between the first contact portions 210c and 210d; the extended portion 340d is disposed between the first contact portions 210d and 210e; the extended portion 340e is disposed between the first contact portions 210e and 210f. The contact faces of the extended portions 340a to 340e is at substantially the same height position as that of the contact faces of the second contact portions 310a to 310e. The portions on the one side in the first direction Y (the distal portions) of the extended portions 340a to 340e are bent to the other side in the second direction Z (to the upper side) and embedded in the tongue 120. This arrangement increases the contact areas of the extended portions 340a to 340e that are in contact with the tongue 120, resulting in increased retaining forces of the tongue 120 with respect to the second contacts 300a to 300e. The bent distal portions of the extended portions 340a to 340e will not reach the first contact portions 210a to 210f because the extended portions 340a to 340e are designed to have the dimensions in the third direction X as described above.

The second contact bodies 320a to 320e are contiguous with the other ends in the first direction Y of the second contact portions 310a to 310e, and they are embedded in the body 100 (particularly in the main body 110 and the tongue 120). The second contact bodies 320a to 320e include first plates 321a to 321e, second plates 322a to 322e, and third plates 323a to 323e. The first plates 321 a to 321 e extend from the second contact portions 310a to 310e to the other side in the first direction Y. As shown in FIGS. 4A and 4B, the second contact portions 310a to 310e and the first plates 321a to 321e are located on the one side in the second direction Z of the first plates 231a to 231f of the first contact bodies 230a to 230f. In other words, the first plates 231a to 231f of the first contact bodies 230a to 230f are located, with spacing, on the other side in the second direction Z of the second contact portions 310a to 310e and the first plates 321a to 321e. The second plates 322a to 322e contiguously extend from the first plates 321a to 321e to the one side in the second direction Z. The third plates 323a to 323e contiguously extend from the second plates 322a to 322e to the other side in the first direction Y. The third plates 323a to 323e are located in the gap between the fifth plate 235c of the first contact body 230c and the fifth plate 235d of the first contact body 230d.

The second tails 330a to 330e are plates contiguous with the second contact bodies 320a to 320e and extend to the other side in the first direction Y. More specifically, the second tails 330a to 330e are contiguous with the third plates 323a to 323e of the second contact bodies 320a to 320e and project from the main body 110 of the body 100 to the other side in the first direction Y. The second tails 330a to 330e are located in the gap between the first tails 240c and 240d. The first tails 240a to 240f and the second tails 330a to 330e are arrayed in a single row along the third direction X. The first tails 240a to 240f and the second tails 330a to 330e are connectable to electrodes of a circuit board of an electronic device mounting the connector C. The electronic device may be a digital camera, a digital video camera, a mobile terminal device such as a mobile phone and a smartphone.

As shown in FIGS. 1A to 2C, 5A, and 5B, the shield case 400 is a tuboid metal member. The shield case 400 includes a bottom plate 410, a pair of inner plates 420, a pair of outer plates 430, a pair of foldover portions 440, a top plate 450, a pair of wings 460, and a lock lever 470.

The bottom plate 410 is a generally rectangular plate. The inner plates 420 are contiguous with the opposite ends in the third direction X of the bottom plate 410. The inner plates 420 are generally rectangular plates extending from the ends of the bottom plate 410 to the other side in the second direction Z (the upper side). The inner plates 420 are each provided with an engageable piece 421 at the end on the other side in the first direction Y. The engageable pieces 421 extend from the ends of the inner plates 420 toward the outer plates 430.

The top plate 450 is a generally rectangular plate. The outer plates 430 are contiguous with the opposite ends in the third direction X of the top plate 450. The outer plates 430 are generally rectangular plates extending from the ends of the top plate 450 to the one side in the second direction Z (to the lower side). The outer plates 430 are arranged outside the inner plates 420. The foldover portions 440 of generally U-shape are contiguous with the respective ends on the one side in the first direction Y of the outer plates 430 and with the respective ends on the one side in the first direction Y of the inner plates 420. Specifically, one end of each foldover portion 440 is contiguous with the end on the one side in the first direction Y of each inner plate 420, and the other end of each foldover portion 440 is contiguous with the end on one side in the first direction Y of each outer plate 430. Engaging holes 431 are provided in the respective ends on the other side in the first direction Y of the outer plates 430 to engage the engageable pieces 421 of the inner plates 420.

The bottom plate 410, the inner plates 420, the outer plates 430, and the top plate 450 in combination form a tuboid shape defining an accommodating space S. The inner shape of the combination of the bottom plate 410, the inner plates 420, outer plates 430, and top plate 450 conforms to the outer shape of the projection 112 of the body 100. The tongue 120 of the body 100 is received in the accommodating space S. The projection 112 fits into the combination of the bottom plate 410, the inner plates 420, the outer plates 430, and the top plate 450. The plate 111 of the body 100 abuts the end faces on the other side in the first direction Y of the bottom plate 410, the inner plates 420, the outer plates 430, and the top plate 450. The top plate 450 is provided with a pair of abuttable portions 451 projecting to the one side in the second direction Z. The abuttable portions 451 are accommodated in the engaging recesses 114 of the body 100 and abut areas on the other side in the first direction Y of the engaging recesses 114. The top plate 450 is also contiguously provided with the lock lever 470, at the center at the end on the other side in the first direction Y. The lock lever 470 is bent to the one side in the second direction Z and engaged in the engaging recess 113 of the body 100. Consequently, the main body 110 of the body 100 is held between the abuttable portions 451 and the lock lever 470. The bottom plate 410, the inner plates 420, the outer plates 430, the top plate 450, the main body 110, and the tongue 120 define a connection hole Si which forms part of the accommodating space S.

The wings 460 are each contiguous with the end on the one side in the second direction Z of each of the outer plates 430. The wings 460 each include a generally L-shaped base and a pair of engageable portions. The base is contiguous with the above-mentioned ends. The engageable portions are provided at the outer end of the base in spaced relation to each other along the first direction Y and extend to the other side in the second direction Z. The engageable portions of the wing 460 may engage holes in a housing or circuit board of an electronic device as exemplified above.

The connector C described above may be assembled in the following steps. The first step is to prepare the first contacts 200a to 200f and the second contacts 300a to 300e. Then, the first contacts 200a to 200f and the second contacts 300a to 300e are placed in a die (not shown). The first contact portions 210b to 210e and the second contact portions 310a to 310e are alternately arranged in the staggered array along the third direction X. The extended portion 340a is disposed between the first contact portions 210a and 210b. The extended portion 340b is disposed between the first contact portions 210b and 210c. The extended portion 340c is disposed between the first contact portions 210c and 210d. The extended portion 340d is disposed between the first contact portions 210d and 210e. The extended portion 340e is disposed between the first contact portions 210e and 210f.

In this arrangement, portions of the first contact bodies 230a to 230f (i.e. the first plates 231a to 231f) are arranged on the other side in the second direction Z of the second contact portions 310a to 310e and portions of the second contact bodies 320a to 320e (i.e. the first plates 321a to 321e). The third plates 323a to 323e of the second contact bodies 320a to 320e are arranged between the fifth plate 235c of the first contact body 230c and the fifth plate 235d of the first contact body 230d. The second tails 330a to 330e are arranged between the first tails 240c and 240d. The first tails 240a to 240f and the second tails 330a to 330e are thus arrayed in a single row.

The next step is to inject insulating plastic material into the die to insert-mold the first contacts 200a to 200f and the second contacts 300a to 300e in the insulating plastic material. The insulating plastic material hardens to form the body 100, embedded with the first contact portions 210a to 210f, the bent portions 220a to 220f, and the first contact bodies 230a to 230f of the first contacts 200a to 200f, and the second contact portions 310a to 310e, the second contact bodies 320a to 320e, and the extended portions 340a to 340e of the second contacts 300a to 300e. Also, the contact faces of the first contact portions 210a to 210f, the contact faces of the second contact portions 310a to 310e, and the contact faces of the extended portions 340a to 340e are exposed from the first face 121 of the tongue 120 of the body 100. The contact faces of the first contact portions 210a to 210f and the contact faces of the second contact portions 310a to 310e form the staggered array along the third direction X. The contact faces of the extended portions 340a to 340e are each disposed between adjacent two of the contact faces of the first contact portions 210a to 210f. The first tails 240a to 240f and the second tails 330a to 330e project from the body 100.

The next step is to prepare the shield case 400. At this stage, the shield case 400 is formed such that the lock lever 470 is not bent and extends to the other side in the first direction Y. The tongue 120 of the body 100 is inserted from the other side in the first direction Y into the accommodating space S of the shield case 400 to fit the projection 112 of the main body 110 into the shield case 400. The plate 111 of the main body 110 abuts the shield case 400. The abuttable portions 451 of the shield case 400 are inserted into the engaging recesses 114 of the body 100 to abut the main body 110. The lock lever 470 is bent to be engaged into the engaging recess 113 of the main body 110. The lock lever 470 abuts the main body 110. Consequently, the main body 110 of the body 100 is held between the abuttable portions 451 and the lock lever 470. Now the connector C is assembled.

The connector C may be connected to the first, second or third mating connector in the following manner. The first mating connector includes a plurality of first mating contacts, which are connectable to the first contacts 200a to 200f, and a connection hole for fitting the tongue 120 therein. The second mating connector includes a plurality of second mating contacts, which are connectable to the second contacts 300a to 300e, and the connection hole. The third mating connector includes the first and second mating contacts and the connection hole.

When the first mating connector is inserted into the connection hole S1 in the connector C, the tongue 120 fits into the connection hole of the first mating connector. The first mating contacts are brought into contact with the contact faces of the first contact portions 210a to 210f of the first contacts 200a to 200f. The first mating connector is thus connected to the connector C. It should be noted that the first contact portions 210a to 210f of the first contacts 200a to 200f and the second contact portions 310a to 310e of the second contacts 300a to 300e form the above staggered array. Therefore, the first mating contacts will not contact the second contact portions 310a to 310e or the extended portions 340a to 340e extending therefrom to the one side in the first direction Y.

When the second mating connector is inserted into connection hole S1 in the connector C, the tongue 120 fits into the connection hole in the second mating connector. The second mating contacts are each guided by the adjacent two guiding projections 122 of the tongue 120 and brought into contact with the contact faces of the second contact portions 310a to 310e of the second contacts 300a to 300e. The second mating connector is thus connected to the connector C (connected state). As stated, the first contact portions 210a to 210f of the first contacts 200a to 200f and the second contact portions 310a to 310e of the second contacts 300a to 300e form the staggered array. Therefore, the second mating contacts will not contact the first contact portions 210a to 210f. Further, if the second mating connector in the connected state moves to the one side in the first direction Y due to impact from outside or other factor, the second mating contacts will contact the contact faces of the extended portions 340a to 340e of the second contacts 300a to 300e. Hence, it is possible to maintain secure contact between the second mating contacts and the second contacts 300a to 300e.

When the third mating connector is inserted into connection hole S1 in the connector C, the tongue 120 fits into the connection hole in the third mating connector. The first mating contacts are brought into contact with the contact faces of the first contact portions 210a to 210f of the first contacts 200a to 200f. The second mating contacts are each guided by the adjacent two guiding projections 122 of the tongue 120 and brought into contact with the contact faces of the second contact portions 310a to 310e of the second contacts 300a to 300e. The third mating connector is thus connected to the connector C (connected state). As stated, the first contact portions 210a to 210f of the first contacts 200a to 200f and the second contact portions 310a to 310e of the second contacts 300a to 300e form the staggered array. Therefore, the first mating contacts will not contact the second contact portions 310a to 310e or the extended portions 340a to 340e extending therefrom to the one side in the first direction Y, and the second mating contacts will not contact the first contact portions 210a to 210f. Further, if the third mating connector in the connected state moves to the one side in the first direction Y due to impact from outside or other factor, the second mating contacts will contact the contact faces of the extended portions 340a to 340e of the second contacts 300a to 300e. Hence, it is possible to maintain secure contact between the third mating contacts and the second contacts 300a to 300e.

The connector C as described above have many technical features. For convenience of explanation, the connector C is compared with a comparative connector as configured below and the conventional connector as described in the introductory part. Assume that the comparative connector has first and second contact portions exposed from opposite faces in the second direction (from the upper and lower faces) of the tongue. This configuration requires to conform the part of the shield case on the one side in the second direction of the tongue to the outer shape of the first mating connector, and to conform the part of the shield case on the other side in the second direction of the tongue to the outer shape of the second mating connector. As a result, the comparative connector has a larger dimension in the second direction.

In contrast, the connector C is configured such that the first contact portions 210a to 210f of the first contacts 200a to 200f and the second contact portions 310a to 310e of the second contacts 300a to 300e are embedded in the tongue 120 in such a manner as to be exposed from the same face, i.e. the first face 121 of the tongue 120. This configuration makes it possible to design the inner shape of the shield case 400 such as to conform to the outer shape of the largest one of the first, second, and third mating connectors. Therefore, the connector C can be designed with a reduced dimension in the second direction Z, as compared with the conventional and comparative connectors.

Further advantageously, the first contact portions 210a to 210f and the second contact portions 310a to 310e are arranged in the staggered array along the third direction X. The bent portions 220a to 220f of the first contacts 200a to 200f are bent to the other side in the second direction Z. The portions of the first contact bodies 230a to 230f are arranged on the other side in the second direction Z of the second contact portions 310a to 310e and the portions of the second contact bodies 320a to 320e. Therefore, exposing the first contact portions 210a to 210f and the second contact portions 310a to 310e from the first face 121 of the tongue 120 does not lead to an increased dimension in the third direction X of the connector C.

Also, the first contact portions 210a to 210f and the second contact portions 310a to 310e form the staggered array along the third direction X. This array allows the connector C to be connected to any of the first, second, and third mating connectors as described above. Further advantageously, if the second (or third) mating connector in the connected state moves to the one side in the first direction Y due to impact from outside or other factor, the connector C can maintain secure contact between the second mating contacts of the second (or third) mating connector and the second contacts 300a to 300e. This improves connection reliability of the connector C.

Further, the first tails 240a to 240f and the second tails 330a to 330e project from the body 100 and are arrayed in a single row. This arrangement can reduce the mounting area in the circuit board. Further, the first contacts 200a to 200f and the second contacts 300a to 300e are insert-molded into the body 100 at a time, thereby simplifying the production process of the connector C. It is therefore possible to fabricate the connector C with a reduced cost.

### Embodiment 2

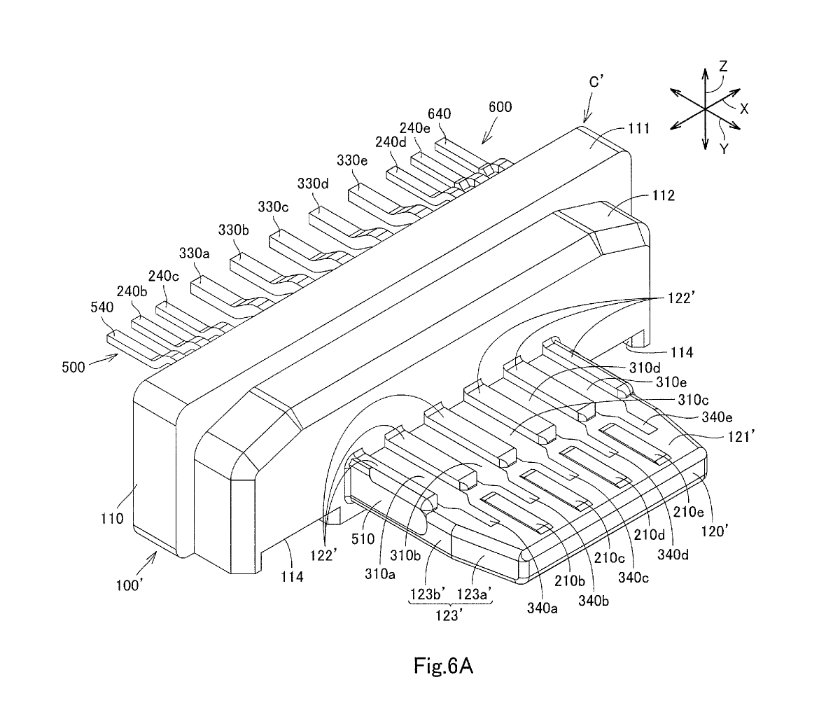

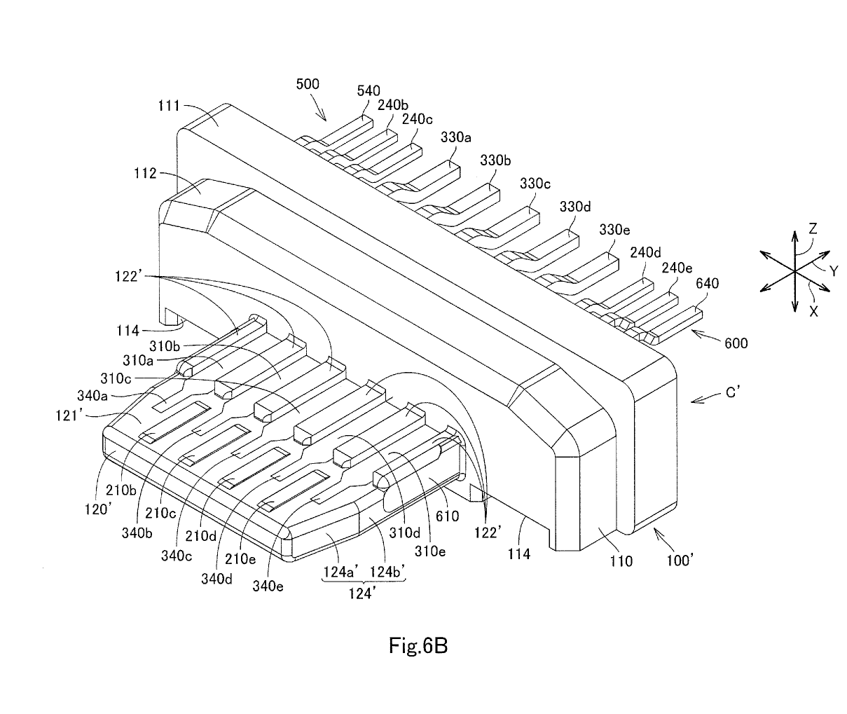

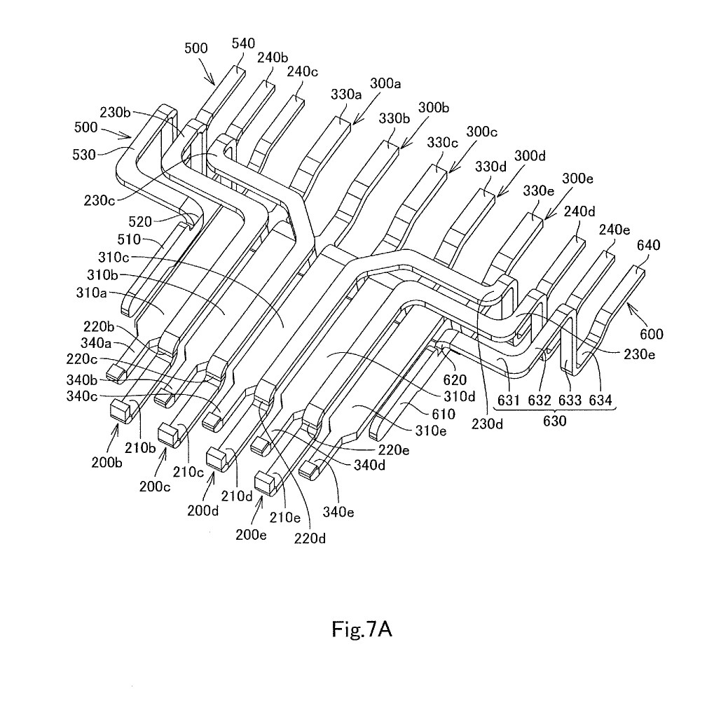

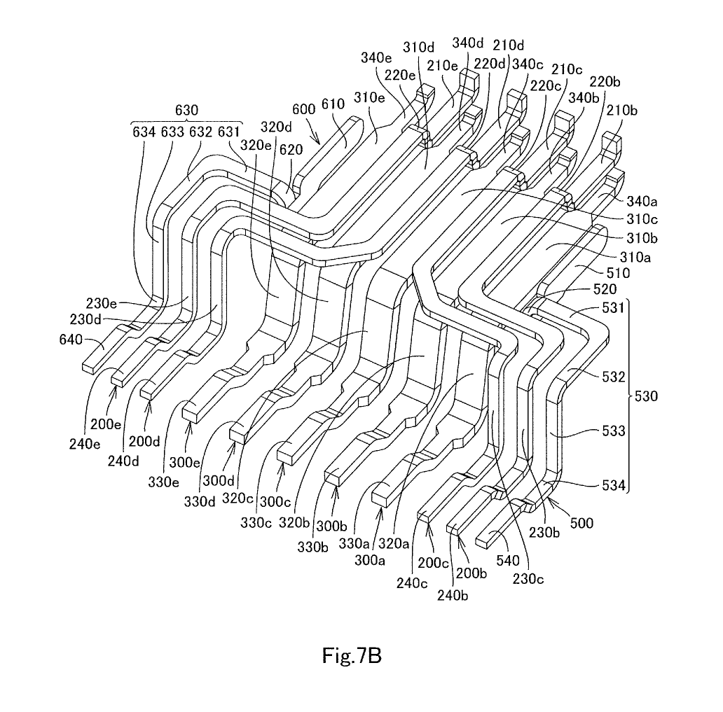

Next, a connector C′ according to Embodiment 2 of the invention will be described with reference to FIGS. 6A to 7B. The connector C′ described here has substantially the same configuration as the connector C of Embodiment 1 except for the first to third differences indicated below. The connector C′ of Embodiment 2 is also a multi-standard connector adapted to two standards. The first difference is that the connector C′ includes a tongue 120′ of a body 100′ of a different from the tongue 120 of the body 100. The second difference is that the connector C′ includes a third contact 500 and a fourth contact 600 in place of the first contacts 200a and 200f. The third difference is that it is the first contacts 200b to 200e, the third contact 500, and the fourth contact 600 that comply with the one of the two standards. These first to third differences of the connector C′ of Embodiment 2 will be described below in detail, without detailed description of substantially the same components of the connector C′ as those of Embodiment 1. In FIGS. 6A and 6B, a shield case, which has the same configuration as the shield case 400, is not illustrated. In addition, FIGS. 6A and 6B indicate the first direction Y, the second direction Z, and the third direction X as defined in Embodiment 1.

As shown in FIGS. 6A and 6B, the tongue 120′ is a generally rectangular plate projecting from the face on the one side in the first direction Y (the front face) of the projection 112 of the main body 110. The tongue 120′ extends from the main body 110 to the one side in the first direction Y. The tongue 120′ includes a distal portion, a basal portion, a first face 121′, a second face 123′, a third face 124′, and a plurality of guiding projections 122′. The first face 121′ is the face on the one side in the second direction Z (the lower side), i.e. the lower face, of the tongue 120′. The first face 121′ includes an area on the one side in the first direction Y (a distal area) and an area on the other side in the first direction Y (a basal area). The distal area of the first face 121′ corresponds to the lower face of the distal portion of the tongue 120′. The basal area of the first face 121′ corresponds to the lower face of the basal portion of the tongue 120′. The basal area of the first face 121′ is formed with guiding projections 122′ in spaced array along the third direction X. The guiding projections 122′ are ridges extending in the first direction Y.

The contact faces of the second contact portions 310a to 310e of the second contacts 300a to 300e are each exposed from between two adjacent ones of the guiding projections 122′ in the basal area of the first face 121′ of the tongue 120′. The extended portion 340a of the second contact 300a is disposed on the one side in the third direction X of the first contact portions 210b. The extended portion 340e of the second contact 300e is disposed on the other side in the third direction X of the first contact portion 210e. The extended portions 340b to 340d of the second contacts 300b to 300d are arranged as described in Embodiment 1. That is, the extended portion 340b is disposed between the first contact portions 210b and 210c. The extended portion 340c is disposed between the first contact portions 210c and 210d. The extended portion 340d is disposed between the first contact portions 210d and 210e.

The second face 123′ of the tongue 120′ includes an area on the one side in the first direction Y (a distal area 123a′) and an area on the other side in the first direction Y (a basal area 123b′). The third face 124′ of the tongue 120′ includes an area on the one side in the first direction Y (a distal area 124a′) and an area on the other side in the first direction Y (a basal area 124b′). The distal area 123a′ corresponds to the side face on the one side in the third direction X of the distal portion of the tongue 120′. The distal area 124a′ corresponds to the side face on the other side in the third direction X of the distal portion of the tongue 120′. The distal areas 123a′ and 124a′ are inclined with respect to the basal areas such that the distance in the third direction X between the distal areas 123a′ and 124a′ is gradually reduced toward the one side in the first direction Y of the tongue 120′. That is, the distal areas 123a′ and 124a′ serve as chamfered faces. The basal area 123b′ corresponds to the side face on the one side in the third direction X of the basal portion of the tongue 120′. The basal area 124b′ corresponds to the side face on the other side in the third direction X of the basal portion of the tongue 120′.

As shown in FIGS. 6A to 7B, the third contact 500 is made of a metal plate. The third contact 500 includes a third contact portion 510, a bent portion 520, a third contact body 530, and a third tail 540.

The third contact portion 510 is a plate extending in the first direction Y and second direction Z and includes a contact face being the end face on the one side in the third direction X. The third contact portion 510 is embedded in the tongue 120′ such that its contact face is exposed from the basal area 123b′ of the second face 123′ of the tongue 120′. The third contact portion 510 is disposed on the one side in the third direction X of the second contact portion 310a of the second contact 300a. The contact face of the third contact portion 510 is flush with the basal area 123b′ of the second face 123′ of the tongue 120′.

The bent portion 520 is contiguous with the rear end of the end face on the other side in the second direction Z (the upper face) of the third contact portion 510, and it is bent to the one side in the third direction X. The bent portion 520 is embedded in the main body 110 of the body 100′.

The third contact body 530 is a plate contiguous with the bent portion 520, embedded in the main body 110 of the body 100′, and disposed on the one side in the third direction X of the first contact body 230b of the first contact 200b. The third contact body 530 includes a first plate 531, a second plate 532, a third plate 533, and a fourth plate 534. The first plate 531 contiguously extends from the bent portion 520 to the one side in the third direction X. The second plate 532 contiguously extends from the first plate 531 to the other side in the first direction Y. The third plate 533 contiguously extends from the second plate 532 to the one side in the second direction Z. The fourth plate 534 contiguously extends from the third plate 533 to the other side in the first direction Y.

The third tail 540 is a plate contiguous with the third contact body 530 and extends to the other side in the first direction Y. More specifically, the third tail 540 is contiguous with the fourth plate 534 of the third contact body 530 and projects from the main body 110 of the body 100′ to the other side in the first direction Y. The third tail 540 is disposed on the one side in the third direction X of the first tail 240b of the first contact 200b.

As shown in FIGS. 6A to 7B, the fourth contact 600 is made of a metal plate. The fourth contact 600 is symmetrically formed to the third contact 500. The fourth contact 600 includes a fourth contact portion 610, a bent portion 620, a fourth contact body 630, and a fourth tail 640.

The fourth contact portion 610 is a plate extending in the first direction Y and second direction Z and includes a contact face being the end face on the other side in the third direction X. The fourth contact portion 610 is embedded in the tongue 120′ such that its contact face is exposed from the basal area 124b′ of the third face 124′ of the tongue 120′. The fourth contact portion 610 is disposed on the other side in the third direction X of the second contact portion 310e of the second contact 300e. The contact face of the fourth contact portion 610 is flush with the basal area 124b′ of the third face 124′ of the tongue 120′.

The bent portion 620 is contiguous with the rear end of the end face on the other side in the second direction Z (the upper face) of the fourth contact portion 610, and it is bent to the other side in the third direction X. The bent portion 620 is embedded in the main body 110 of the body 100′.

The fourth contact body 630 is a plate contiguous with the bent portion 620, is embedded in the main body 110 of the body 100′, and is disposed on the other side in the third direction X of the first contact body 230e of the first contact 200e. The fourth contact body 630 includes a first plate 631, a second plate 632, a third plate 633, and a fourth plate 634. The first plate 631 contiguously extends from the bent portion 620 to the other side in the third direction X. The second plate 632 contiguously extends from the first plate 631 to the other side in the first direction Y. The third plate 633 contiguously extends from the second plate 632 to one side in the second direction Z. The fourth plate 634 contiguously extends from the third plate 633 to the other side in the first direction Y.

The fourth tail 640 is a plate contiguous with the fourth contact body 630 and extends to the other side in the first direction Y. More specifically, the fourth tail 640 is contiguous with the fourth plate 634 of the fourth contact body 630 and projects from the main body 110 of the body 100′ to the other side in the first direction Y. The fourth tail 640 is disposed on the other side in the third direction X of the first tail 240e of the first contact 200e.

The connector C′ described above may be assembled in the following steps. The first step is to prepare the first contacts 200b to 200e, the second contacts 300a to 300e, the third contact 500, and the fourth contact 600. Then, these contacts are placed in a die (not shown). The first contact portions 210b to 210e and the second contact portions 310a to 310e are alternately arranged in a staggered array along the third direction X. The extended portion 340a is disposed on the one side in the third direction X of the first contact portion 210b. The extended portion 340b is disposed between the first contact portions 210b and 210c. The extended portion 340c is disposed between the first contact portions 210c and 210d. The extended portion 340d is disposed between the first contact portions 210d and 210e. The extended portion 340e is disposed on the other side in the third direction X of the first contact portion 210e. The third contact portion 510 is disposed on the one side in the third direction X of the second contact portion 310a, while the fourth contact portion 610 is disposed on the other side in the third direction X of the second contact portion 310e.

In this arrangement, portions of the first contact bodies 230b to 230e (the first plates) are arranged on the other side in the second direction Z of the second contact portions 310a to 310e and portions of the second contact bodies 320a to 320e (the first plates). The third plates of the second contact bodies 320a to 320e are arranged between the fifth plate of the first contact body 230c and the fifth plate of the first contact body 230d. The third contact body 530 is disposed on the one side in the third direction X of the first contact body 230b. The fourth contact body 630 is disposed on the other side in the third direction X of the first contact body 230e. Also, the second tails 330a to 330e are arranged between the first tails 240c and 240d. The third tail 540 is disposed on the one side in the third direction X of the first tail 240b. The fourth tail 640 is disposed on the other side in the third direction X of the first tail 240e. The first tails 240b to 240e, the second tails 330a to 330e, the third tail 540, and the fourth tail 640 are thus arrayed in a single row.

The next step is to inject insulating plastic material into the die to insert-mold the first contacts 200b to 200e, the second contacts 300a to 300e, the third contact 500, and the fourth contact 600 in the insulating plastic material. The insulating plastic material hardens to form the body 100′, embedded with the first contact portions 210b to 210e, the bent portions 220b to 220e, and the first contact bodies 230b to 230e of the first contacts 200b to 200e, the second contact portions 310a to 310e, the second contact bodies 320a to 320e, the extended portions 340a to 340e of the second contacts 300a to 300e, the third contact portion 510, the bent portion 520, and the third contact body 530 of the third contact 500, and the fourth contact portion 610, the bent portion 620, and the fourth contact body 630 of the fourth contact 600. Also, the contact faces of the first contact portions 210b to 210e, the contact faces of the second contact portions 310a to 310e, and the contact faces of the extended portions 340a to 340e are exposed from the first face 121′ of the tongue 120′ of the body 100′. The contact faces of the first contact portions 210b to 210e and the contact faces of the second contact portions 310a to 310e form the staggered array along the third direction X. The contact faces of the first contact portions 210b to 210e are each disposed between adjacent two of the contact faces of the extended portions 340a to 340e. The contact face of the third contact portion 510 of the third contact 500 is exposed from the second face 123′ of the tongue 120′. The contact face of the fourth contact portion 610 of the fourth contact 600 is exposed from the third face 124′ of the tongue 120′. The first tails 240a to 240f, the second tails 330a to 330e, the third tail 540, and the fourth tail 640 project from the body 100′.

The next step is to attach the same shield case as the shield case 400 to the body 100′ in a similar manner to Embodiment 1. Now the connector C′ is assembled.

The connector C′ may be connected to the first, second or third mating connector in the following manner. A connection hole of the connector C′ forms part of the accommodating space S and is defined by the bottom plate, the inner plates, the outer plates, and the top plate of the shield case, the main body 110, and the tongue 120′.

When the first mating connector is inserted into the connection hole in the connector C′, the tongue 120′ fits into the connection hole in the first mating connector. The first mating contacts are brought into contact with the contact faces of the first contact portions 210b to 210e of the first contacts 200b to 200e, the contact face of the third contact portion 510 of the third contact 500, and the contact face of the fourth contact portion 610 of the fourth contact 600. It should be noted that the first contact portions 210b to 210e of the first contacts 200b to 200e and the second contact portions 310a to 310e of the second contacts 300a to 300e form the above staggered array. Therefore, on the first face 121′ of the tongue 120′, the first mating contacts will not contact the second contact portions 310a to 310e and the extended portions 340a to 340e extending therefrom to the one side in the first direction Y.

When the second mating connector is inserted into the connection hole in the connector C′, the tongue 120′ fits into the connection hole in the second mating connector. The second mating contacts are each guided by the adjacent two guiding projections 122′ of the tongue 120′ and brought into contact with the contact faces of the second contact portions 310a to 310e of the second contacts 300a to 300e. The second mating connector is thus connected to the connector C′ (connected state). As stated, the first contact portions 210b to 210e of the first contacts 200b to 200e and the second contact portions 310a to 310e of the second contacts 300a to 300e form the staggered array. Therefore, on the first face 121′ of the tongue 120′, the second mating contacts will not contact the first contact portions 210b to 210e. Further, if the second mating connector in the connected state moves to the one side in the first direction Y due to impact from outside or other factor, the second mating contacts will contact the contact faces of the extended portions 340a to 340e of the second contacts 300a to 300e. Hence, it is possible to maintain secure contact between the second mating contacts and the second contacts 300a to 300e.

When the third mating connector is inserted into the connection hole in the connector C′, the tongue 120′ fits into the connection hole in the third mating connector. The first mating contacts are brought into contact with the contact faces of the first contact portions 210b to 210e of the first contacts 200b to 200e, the contact face of the third contact portion 510 of the third contact 500, and the contact face of the fourth contact portion 610 of the fourth contact 600. The second mating contacts each guided by the adjacent two guiding projections 122′ of the tongue 120′ and brought into contact with the contact faces of the second contact portions 310a to 310e of the second contacts 300a to 300e. The third mating connector is thus connected to the connector C′ (connected state). As stated, the first contact portions 210b to 210e and the second contact portions 310a to 310e form the staggered array. Therefore, on the first face 121′ of the tongue 120′, the first mating contacts will not contact the second contact portions 310a to 310e or the extended portions 340a to 340e extending therefrom to the one side in the first direction Y, and the second mating contacts will not contact the first contact portions 210b to 210e. Further, if the third mating connector in the connected state moves to the one side in the first direction Y due to impact from outside or other factor, the second mating contacts will contact the contact faces of the extended portions 340a to 340e of the second contacts 300a to 300e. Hence, it is possible to maintain secure contact between the third mating contacts and the second contacts 300a to 300e.

The connector C′ as described above have many technical features. The first contact portions 210b to 210e of the first contacts 200b to 200e and the second contact portions 310a to 310e of the second contacts 300a to 300e are embedded in the tongue 120′ in such a manner as to be exposed from the first face 121′ of the tongue 120′. The third contact portion 510 of the third contact 500 and the fourth contact portion 610 of the fourth contact 600 are embedded in the tongue 120′ in such a manner as to be exposed from the second face 123′ and the third face 124′ of the tongue 120′. This configuration makes it possible, as in Embodiment 1, to design the inner shape of the shield case 400 such as to conform to the outer shape of the largest one of the first, second, and third mating connectors. Therefore, the connector C′ can be designed with a reduced dimension in the second direction Z, as compared with the conventional and comparative connectors described above.

Further advantageously, the first contact portions 210b to 210e and the second contact portions 310a to 310e are arranged in the above staggered array along the third direction X. The bent portions 220b to 220e of the first contacts 200b to 200e are bent to the other side in the second direction Z. The portions of the first contact bodies 230b to 230e are arranged on the other side in the second direction Z of the second contact portions 310a to 310e and the portions of the second contact bodies 320a to 320e. Therefore, exposing the first contact portions 210b to 210e and the second contact portions 310a to 310e from the first face 121′ of the tongue 120′ does not lead to an increased dimension in the third direction X of the connector C′. In addition, the third contact portion 510 of the third contact 500 and the fourth contact portion 610 of the fourth contact 600 are embedded in the tongue 120′ in such a manner as to be exposed from the second face 123′ and the third face 124′, respectively, of the tongue 120′ facing the third direction X. Therefore, the addition of the third contact 500 and the fourth contact 600 will not lead to increased dimensions in the second direction Z and the third direction X of the connector C′.

Further, the third contact portion 510 and the fourth contact portion 610 embedded in the basal area 123b′ of the second face 123′ and the basal area 124b′ of the third face 124′ (the side faces on one and the other side in the third direction X of the basal portion) of the tongue 120′ function as reinforcers reinforcing the tongue 120′. This arrangement improves the prying resistance of the tongue 120′ and thereby improves the prying resistance of the connector C′.

Further advantageously, the first contact portions 210b to 210e and the second contact portions 310a to 310e are arranged in the staggered array along the third direction X. The third contact portion 510 of the third contact 500 and the fourth contact portion 610 of the fourth contact 600 are exposed from the second face 123′ and the third face 124′ of the tongue 120′ facing the third direction X. This array of the first to fifths contacts allows the connector C′ to be connected to any of the first, second, and third mating connectors as described above. Further advantageously, if the second (or third) mating connector in the connected state moves to the one side in the first direction Y due to impact from outside or other factor, the connector C′ can maintain secure contact between the second mating contacts of the second (or third) mating connector and the second contacts 300a to 300e. This improves connection reliability of the connector C′. Also, the distal area 123a′ of the second face 123′ of the tongue 120′ and the distal area 124a′ of the third face 124′ of the tongue 120′ serve as chamfered faces. This configuration facilitates the fitting of the tongue 120′ into the connection hole of the first, second, or third mating connector.

Further, the first tails 240b to 240e, the second tails 330a to 330e, the third tail 540, and the fourth tail 640 project from the body 100′ and are arrayed in a single row. This arrangement can reduce the mounting area in the circuit board. Further, the first contacts 200b to 200e, the second contacts 300a to 300e, the third contact 500, and the fourth contact 600 are insert-molded into the body 100 at a time, thereby simplifying the production process of the connector C′. It is therefore possible to fabricate the connector C′ with a reduced cost.

The connectors C and C′ are not limited to the configurations of Embodiments 1 and 2 but may be modified in any manner in accordance of the claims. Some of specific modifications will be described below.

The body 100 of In Embodiment 1 includes the main body 110, and the tongue 120, and the main body 110 includes the plate 111, the projection 112, the engaging recess 113, and the pair of engaging recesses 114. The body 100′ of Embodiment 2 includes the main body 110, and the tongue 120′, and the main body 110 includes the plate 111, the projection 112, the engaging recess 113, and the pair of engaging recesses 114. However, the body of the invention may be modified to any body including a main body and a tongue extending from the main body to one side in a first direction. For instance, the body may further include a tuboid portion provided in the main body. In this case, the tongue may be disposed in the tuboid portion. The tuboid portion, the main body, and the tongue may define the connection hole to receive the first, second, and/or third mating connectors.

The tongue 120 of Embodiment 1 includes the first face 121, and the guiding projections 122. The tongue 120′ of Embodiment 2 includes the first face 121′, the guiding projections 122′, the second face 123′, and the third face 124′. However, the tongue may be modified to any tongue including a first face on one side in the second direction crossing the first direction. That is, the guiding projections 122 may be omitted.

In Embodiment 2, the distal area 123a′ of the second face 123′ of the tongue 120′ and the distal area 124a′ of the third face 124′ of the tongue 120′ are inclined with respect to the basal areas such that the distance between the distal areas 123a′ and 124a′ is gradually reduced toward the one side in the first direction Y of the tongue 120′. However, the second and third faces of the tongue of the invention are not limited to this configuration. For instance, the second and third faces of the tongue may extend in the first direction, in flush with the basal areas. In addition, the distal area of the second face of the tongue and the distal area of the third face of the tongue may be curved such that the distance between the distal areas is gradually reduced toward the one side in the first direction of the tongue.

The first contacts 200a to 200f of Embodiment 1 have the first contact portions 210a to 210f, the bent portions 220a to 220f, the first contact bodies 230a to 230f, and the first tails 240a to 240f. The first contacts 200b to 200e of Embodiment 2 have the first contact portions 210b to 210e, the bent portions 220b to 220e, the first contact bodies 230b to 230e, and the first tails 240b to 240e. However, the first contacts of the invention may be modified in any manner if meeting the following two conditions. The first condition is that the first contacts are embedded at least partially in the body. The second condition is that the first contacts have the first contact portions are embedded in the tongue in spaced relation to each other along the third direction to be exposed from the first face of the tongue of the body. Accordingly, the bent portions may be omitted.

The first contact portions 210a to 210f of Embodiment 1 are plates extending in the first direction Y and the third direction X and embedded in the tongue 120 such that their contact faces, being the end faces on the one side in the second direction Z (the lower side), are spaced from each other in the third direction X and are exposed from the distal area of the first face 121 of the tongue 120. The first contact portions 210b to 210e of Embodiment 2 are plates extending in the first direction Y and third direction X and embedded in the tongue 120′ such that their contact faces, being the end faces on the one side in the second direction Z (the lower side), are spaced from each other in the third direction X and are exposed from the distal area of the first face 121′ of the tongue 120′. However, the first contact portions of the invention may be modified in any manner as long as they are embedded in the tongue in spaced relation to each other along the third direction to be exposed from the first face of the tongue of the body. For instance, the first contact portions may be embedded in the tongue such that their portions other than the contact faces are exposed from the first face of the tongue. That is, the shapes and areas of the portions of the first contact portions exposed from the first face may be modified in any manner. The first contact portions may be of any shape.

The first contact bodies 230a to 230f of Embodiment 1 have the first plates 231a to 231f, the second plates 232a to 232f, the third plates 233a to 233f, the fourth plates 234a to 234f, and the fifth plates 235a to 235f. The first contact bodies 230b to 230e of Embodiment 2 have the first plates 231 b to 231 e, the second plates 232b to 232e, the third plates 233b to 233e, the fourth plates 234b to 234e, and the fifth plates 235b to 235e. However, the first contact bodies of the invention may be modified in any manner as long as they are embedded in the body. For instance, the first contact bodies may be disposed at least partially on the other side in the second direction of the second contact portions. In addition, if the bent portions are omitted as stated above, the first contact bodies may be contiguous with the first contact portions and arranged between the second contact bodies. The first contact bodies may be of any shape. For instance, the first contact bodies may have a shape extending in the first direction or a step-like shape like the second contact bodies 320a to 320e.

The second contacts 300a to 300e of Embodiments 1 and 2 have the second contact portions 310a to 310e, the second contact bodies 320a to 320e, the second tails 330a to 330e, and the extended portions 340a to 340e. However, the second contacts of the invention may be modified in any manner if meeting the following two conditions. The first condition is that that the second contacts are embedded at least partially in the body. The second condition is that the second contacts have the second contact portions embedded in the tongue in spaced relation to each other along the third direction to be exposed from the first face of the tongue. Accordingly, the extended portions may be omitted.

The second contact portions 310a to 310e of Embodiments 1 and 2 are plates extending in the first direction Y and third direction X and embedded in the tongue 120 such that their contact faces, being the end faces on one side in the second direction Z (the lower side), are exposed from between the guiding projections 122 in the basal area of the first face 121 of the tongue 120. However, the second contact portions of the invention may be modified in any manner as long as they are embedded in the tongue in spaced relation to each other along the third direction to be exposed from the first face of the tongue. Therefore, the first and second contact portions may be modified to be arrayed at equal spacing along the third direction in a row or two. The second contact portions may be located on the one side in the first direction of the first contact portions. The shapes and areas of the portions of the second contact portions exposed from the first face may be modified in any manner. The second contact portions may be of any shape.

The second contact bodies 320a to 320e of Embodiments 1 and 2 have the first plates 321a to 321e, the second plates 322a to 322e, and the third plates 323a to 323e. However, the second contact bodies of the invention may be modified in any manner as long as they are embedded in the body. Accordingly, the second contact bodies may be of any shape. For instance, the second contact bodies may have a shape extending in the first direction.

The third contact 500 of Embodiment 2 includes the third contact portion 510, the bent portion 520, the third contact body 530, and the third tail 540. However, the third contact of the invention may be modified to any contact including the third contact portion embedded in the tongue to be exposed from the second face of the tongue. For instance, the third contact may include the third contact portion, and the third contact body embedded in the body on the one side in the third direction of the first or second contact body. Alternatively, the third contact may include the third contact portion, the third contact body embedded in the body on the one side in the third direction of the first or second contact body, and the third tail.

The fourth contact 600 of Embodiment 2 includes the fourth contact portion 610, the bent portion 620, the third contact body 630, and the fourth tail 640. However, the fourth contact of the invention may be modified in any manner as long as it includes the fourth contact portion embedded in the tongue to be exposed from the third face of the tongue. For instance, the fourth contact may have the fourth contact portion, and the fourth contact body embedded in the body on the other side in the third direction of the first or second contact body. Alternatively, the fourth contact may have the fourth contact portion, the fourth contact body embedded in the body on the other side in the third direction of the first or second contact body, and the fourth tail.

The third contact portion 510 of Embodiment 2 is embedded in the tongue 120′ such that the contact face thereof is exposed from the basal area 123b′ of the second face 123′ of the tongue 120′. However, the third contact portion of the invention may be modified in any manner as long as it is embedded in the tongue to be exposed from the second face of the tongue. For instance, the third contact portion may be embedded in the tongue to be exposed from the distal area of the second face of the tongue. Alternatively, the third contact portion may be embedded in the tongue such that the portion thereof other than the contact face is exposed from the second face of the tongue. That is, the shape and area of the portion of the third contact portion exposed from the second face may be modified in any manner. The third contact portion may be of any shape.

The fourth contact portion 610 of Embodiment 2 is embedded in the tongue 120′ such that the contact face thereof is exposed from the basal area 124b′ of the third face 124′ of the tongue 120′. However, the fourth contact portion of the invention may be modified in any manner as long as it is embedded in the tongue to be exposed from the third face of the tongue. For instance, the fourth contact portion may be embedded in the tongue to be exposed from the distal area of the third face of the tongue. Alternatively, the fourth contact portion may be embedded in the tongue such that the portion thereof other than the contact face thereof is exposed from the third face of the tongue. That is, the shape and area of the portion of the fourth contact portion exposed from the second face may be modified in any manner. The fourth contact portion may be of any shape.

In Embodiment 1, the first tails 240a to 240f and the second tails 330a to 330e are arrayed in a single row along the third direction X, and the second tails 330a to 330e are arrayed in the gap between the first tails 240c and 240d. In Embodiment 2, the first tails 240b to 240e, the second tails 330a to 330e, the third tail 540, and the fourth tail 640 are arrayed in a single row in the third direction X, and the second tails 330a to 330e are arrayed in the gap between the first tails 240c and 240d. However, the first and second tails of the invention are not limited to these configurations. For instance, if the first and second contacts are connected in the body to a circuit board or a connecting member (e.g., a cable and a connecting pin) embedded in the body, the first and second tails may be omitted. In addition, the first and second tails may project from the body and are alternately arrayed in spaced relation to each other along the third direction. Alternatively, the first tails may project from the body to be arrayed in a single row along a first position, and the second tails may project from the body to be arrayed in a single row along a second position that is on one or the other side in the first direction Y of the first position. The third and fourth tails may be located at any positions. For instance, the third and fourth tails may be arrayed between the first tails, between the second tails, or between the first and second tails. In addition, the third and fourth tails may be arrayed in the first position and/or in the second position. Further, the first, second, and third and/or fourth tails may project from the body in the second direction.

The shield case as described above may be omitted. Alternatively, there may be provided any shield case adapted to partially cover the body. For instance, the shield case may be of a tuboid shape adapted to cover the entire outer peripheral surface of the main body. In this case, the shield case may be of a shape adapted to receive the tongue, or of a shape incapable of receiving the tongue. If the body includes a tuboid portion as described above, the shield case may cover the entire outer peripheral surface of the main body and the tuboid portion, and may cover part of the body (e.g., the main body or the tuboid portion).

The materials, shapes, dimensions, numbers, and arrangements, and other configurations of constituents of the connector C of Embodiment 1 and the connector C′ of Embodiment 2 are described by way of example only and may be modified in any manner as long as they may provide similar functions. For instance, the first and second contacts and/or the shield case may be of any electrically conductive material. The first and second contacts may comply with a same standard. The first, third, and fourth contacts and the second contact may comply with a same standard. The first to fourth contacts may comply with different standards. The first to fourth contacts may not be insert-molded in the body. For instance, the first and/or second contacts may be inserted into holes or grooves in the body. At least one of the first to fourth contacts may be inserted into holes or grooves in the body. The first direction may be any direction. The second direction may be any direction crossing the first direction. The third direction may be any direction crossing the first and second directions. The connector may be connectable to the first and second mating connectors only. The connector may be connectable to the first or second mating connector and the third mating connector.

### Reference Signs List

100: Body
110: Main body
120: Tongue
   121: First face

200a to 200f: First contact
210a to 210f: First contact portion
220a to 220f: Bent portion
230a to 230f: First contact body
240a to 240f: First tail

300a to 300e: Second contact
310a to 310e: Second contact portion
320a to 320e: Second contact body
330a to 320e: Second tail
340a to 340e: Extended portion

400: Shield case
100′: Body
110′: Main body
120′: Tongue
   121′: First face
   123′: Second face
   124′: Third face

500: Third contact
510: Third contact portion
520: Bent portion
530: Third contact body
540: Third tail

600: Fourth contact
610: Fourth contact portion
620: Bent portion
630: Fourth contact body
640: Fourth tail

Y: First direction

Z: Second direction

X: Third direction

1. A connector comprising:
a body, the body including:
a main body, and
a tongue extending from the main body to one side in a first direction, the tongue including a first face facing one side in a second direction, the second direction crossing the first direction;
a plurality of first contacts, being embedded at least partially in the body and including first contact portions, the first contact portions being embedded in the tongue in spaced relation to each other along a third direction crossing the first and second directions to be exposed from the first face of the tongue; and
a plurality of second contacts, being embedded at least partially in the body and including second contact portions, the second contact portions being embedded in the tongue in spaced relation to each other along the third direction to be exposed from the first face of the tongue.

2. The connector according to claim 1,
wherein the first and second contact portions are alternately arrayed to form a staggered array along the third direction.

3. The connector according to claim 2, wherein
the second contacts further include second contact bodies embedded in the body,
the first contacts further include:
bent portions extending to the other side in the second direction and embedded in the tongue, and
first contact bodies contiguous with respect to the bent portions, bent with respect to the bent portions to the other side in the first direction and embedded in the body to be located on the other side in the second direction of the second contact portions.

4. The connector according to claim 2, wherein
the second contact portions are embedded in the tongue in spaced relation to each other along the third direction to be exposed from an area of the first face of the tongue on the other side in the first direction from the first contact portions,
the second contacts further include extended portions, the extended portions extending from the second contact portions to the one side in the first direction and being embedded in the tongue to be each exposed from between adjacent two of the first contact portions in the first face of the tongue.

5. The connector according to claim 3, wherein
the second contact portions are embedded in the tongue in spaced relation to each other along the third direction to be exposed from an area of the first face of the tongue on the other side in the first direction from the first contact portions,
the second contacts further include extended portions, the extended portions extending from the second contact portions to the one side in the first direction and being embedded in the tongue to be each exposed from between adjacent two of the first contact portions in the first face of the tongue.

6. The connector according to claim 1, further comprising third and fourth contacts embedded at least partially in the body, wherein
the tongue further includes:
a second face on one side in the third direction of the tongue, and
a third face on the other side in the third direction of the tongue,
the third contact includes a third contact portion, the third contact portion being embedded in the tongue to be exposed from the second face of the tongue, and
the fourth contact includes a fourth contact portion, the fourth contact portion being embedded in the tongue to be exposed from the third face of the tongue.

7. The connector according to claim 2, further comprising third and fourth contacts embedded at least partially in the body, wherein
the tongue further includes:
a second face on one side in the third direction of the tongue, and
a third face on the other side in the third direction of the tongue,
the third contact includes a third contact portion, the third contact portion being embedded in the tongue to be exposed from the second face of the tongue, and
the fourth contact includes a fourth contact portion, the fourth contact portion being embedded in the tongue to be exposed from the third face of the tongue.

8. The connector according to claim 3, further comprising third and fourth contacts embedded at least partially in the body, wherein
the tongue further includes:
a second face on one side in the third direction of the tongue, and
a third face on the other side in the third direction of the tongue,
the third contact includes a third contact portion, the third contact portion being embedded in the tongue to be exposed from the second face of the tongue, and
the fourth contact includes a fourth contact portion, the fourth contact portion being embedded in the tongue to be exposed from the third face of the tongue.

9. The connector according to claim 4, further comprising third and fourth contacts embedded at least partially in the body, wherein
the tongue further includes:
a second face on one side in the third direction of the tongue, and
a third face on the other side in the third direction of the tongue;
the third contact includes a third contact portion, the third contact portion being embedded in the tongue to be exposed from the second face of the tongue, and
the fourth contact includes a fourth contact portion, the fourth contact portion being embedded in the tongue to be exposed from the third face of the tongue.

10. The connector according to claim 6, wherein
the second and third faces of the tongue each include a distal area on the one side in the first direction and a basal area on the other side in the first direction,
the third contact portion is embedded in the tongue to be exposed from the basal area of the second face, and
the fourth contact portion is embedded in the tongue to be exposed from the basal area of the third face.

11. The connector according to claim 10, wherein the distal areas of the second and third faces are inclined with respect to the basal areas such that the distance between the distal areas is gradually reduced toward the one side in the first direction of the tongue.

12. The connector according to claim 6, wherein
the third contact further includes a third contact body embedded in the body, and
the fourth contact further includes a fourth contact body embedded in the body.

13. The connector according claim 1, wherein
the first contacts further include first tails projecting from the main body, and
the second contacts further include second tails projecting from the main body.

14. The connector according to claim 13, wherein
the first and second tails are arrayed in spaced relation to each other in a row along the third direction.

15. The connector according to claim 6, wherein
the first contacts further include first tails projecting from the main body,
the second contacts further include second tails projecting from the main body,
the third contact further includes a third tail projecting from the main body, and
the fourth contact further includes a fourth tail projecting from the main body.

16. The connector according to claim 15, wherein
the first, second, third, and fourth tails arc arrayed in spaced relation to each other in a row along the third direction.

17. The connector according to claim 1, further comprising a tuboid shield case fixed to the main body,
wherein the tongue is disposed in the shield case.

18. The connector according to claim 1, further comprising a tuboid shield case covering at least a part of the body, wherein
the body further includes a tuboid portion provided in the main body, and
the tongue is disposed in the tuboid portion.

19. The connector according to claim 1, wherein
the second contacts comply with a Micro-USB standard.

20. An electronic device comprising the connector according to claim 1.
